(19) United States
(12) Patent Application Publication
(10) Pub. No.: US 2008/0291936 A1
(43) Pub. Date: Nov. 27, 2008

(54) TEMPORARY BLOCK FLOW CONTROL IN WIRELESS COMMUNICATION DEVICE

(75) Inventors: YOUNG JUN LEE, WAUKEGAN, IL (US); ALBERTO GUTIERREZ, BUFFALO GROVE, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/753,734

(22) Filed: May 25, 2007

(51) Int. Cl. H04L 12/56

(52) U.S. Cl. 370/412

(57) ABSTRACT

A wireless communication device (300) including a voice activity detector (330), and a codec (320) outputting an audio data packet based on a transducer (310) output after the onset of audio input thereto. A control module prompts initiating setup of a temporary block flow when the voice activity detector detects audio input to the transducer. The control module also prompts initiating setup of the temporary block flow before the audio data packet is output to a buffer.

The present disclosure relates generally to wireless communications, and more particularly to controlling temporary block flow in a wireless communication device, for example, in a General Packet Radio Service enabled Global System for Mobile Communications mobile station.

### BACKGROUND

General Packet Radio Service (GPRS) is a mobile data service in Global System for Mobile Communications (GSM) protocol networks. Temporary Block Flow (TBF) is a connection established between a Mobile Station (MS) and a Base Station (BS) to enable packet exchanges between the BS and MS entities in GPRS networks. The current TBF handling in GPRS is based upon burst traffic models, such as Web surfing and email transfer. TBF setup is initiated upon buffering a packet for transmission in the MS. In GPRS, TBF set-up is performed on a random access channel (RACH) and requires some time. The TBF set-up delay however adversely affects the performance of some real-time applications such as Voice over Internet Protocol (VoIP) among other delay sensitive applications. TBF is released when all buffered packets are de-queued before the arrival of the next packet. This release mechanism may result in frequent TBF re-establishments and associated delays for some applications, for example, in VoIP applications, which include a sequence of packets containing voice frames are regularly separated by an inter-arrival time within a talk spurt illustrated in FIG. 1. Frequent TBF setup/release events may also unnecessarily increase signaling overhead.

3GPP Release 4 and later releases include enhancements that support an extended uplink TBF mode and delayed release of the downlink TBF. Release 4 allows temporary inactive voice periods where the MS has no packets to send, thereby avoiding multiple TBF releases and re-establishments. In Release 4, however, TBF release is controlled by the network and thus the MS must rely on the network for these features. In Release 4 these enhanced features may have an adverse impact on MS power consumption. Moreover, the inactive period is relatively short and typically does not exceed 5 seconds.

The various aspects, features and advantages of the disclosure will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 illustrates a prior art active interval containing a sequence of packets separated by an inter-arrival time.

FIG. 2 is a process for prompting the initiation of temporary block flow setup.

FIG. 3 is a block diagram of a wireless communication device.

FIG. 4 illustrates a time-line associated with the generation of voice packets.

FIG. 5 is a process for maintaining temporary block flow.

### DETAILED DESCRIPTION

The disclosure is drawn to the setup and management of temporary block flow in a wireless communication device and corresponding methods therein. Temporary block flow (TBF) is a connection between a wireless communication and a communication network infrastructure entity, for example, a base station (BS) that is supports the communication of packet data. In one embodiment, the wireless communication device is a General Packet Radio Service (GPRS) enabled Global System for Mobile Communications (GSM) mobile station (MS). More generally, however, the wireless communication device may communicate packet data pursuant to any communications protocol in which temporary block flow or other packet data communication link is required.

FIG. 2 is a schematic diagram of a process in a wireless communication device for prompting the initiation of temporary block flow. An exemplary application is voice over IP (VoIP) wherein the wireless communication device transmits packets containing audio or voice data. The VoIP may be implemented in a cellular communication network (VoC) or in some other packet data network. In FIG. 2, at 210, the wireless communication device detects audio, for example, voice activity input to a microphone in a cellular handset or other wireless communications device, when the wireless communication device is not in a temporary block flow.

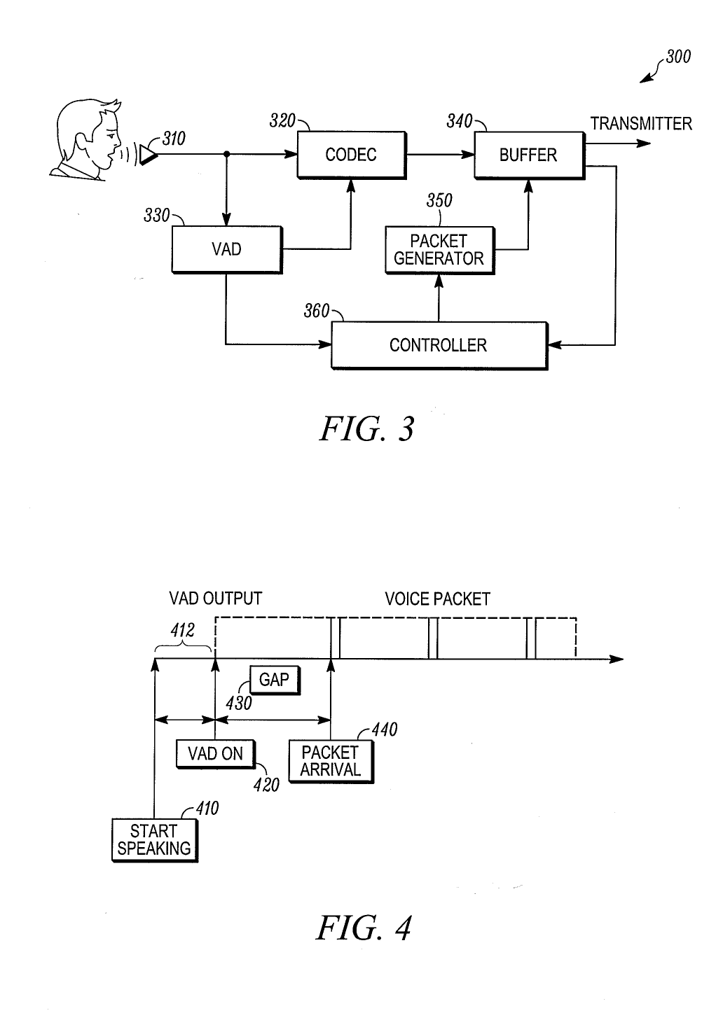

In the wireless communication device 300 of FIG. 3, a transducer 310 generates an electrical signal based upon an audible pressure wave received at an input thereof. The electrical signal is communicated to a codec 320, which generates packets based upon input received from the output of the transducer, as discussed further below. The onset and presence of the audio or voice activity at the input of the transducer is detected by voice activity detector (VAD) 320 coupled to the transducer output. In one embodiment, the VAD transitions from an OFF state to an ON state upon detecting the onset of voice activity. The transducer remains ON when voice activity is present and transitions to an OFF state when the voice activity is discontinued. In some embodiments, the VAD may delay the transition to the OFF state for some specified interval upon the cessation of voice activity to accommodate pauses in speech to prevent unnecessary cycling of the VAD during speech. This delay may be based upon empirical evidence obtained over a statistical sampling of the speech characteristics of a population of typical users. In other embodiments, the onset and/or presence of audio or voice activity may be detected by some other detector.

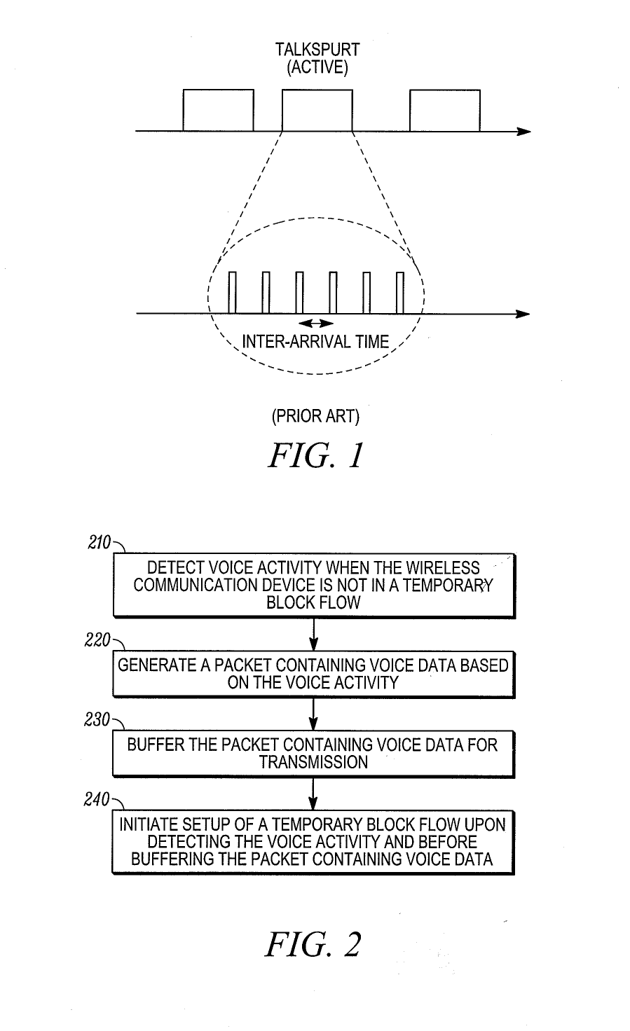

In FIG. 2, at 220, one or more packets containing voice data are generated based on voice activity input to the audio transducer, which is typically a microphone. In one embodiment, a codec, for example, the codec 320 in FIG. 3, generates a sequence of packets based upon the transducer output. In one application, a sequence of regularly spaced packets are separated by a fixed inter-arrival time to form packet group or talk spurt as illustrated in FIG. 1. In some applications, the packets may contain one or more frames. The codec generates and outputs packets to the buffer at a limited rate. The packet generation rate is typically determined by the frame generation rate of the codec of choice and the frame packing policy. In one embodiment, the operation of the codec is controlled by the operation of the VAD. According to this embodiment, the VAD enables the codec only upon detection of voice activity to prevent the codec from outputting packets based on noise input to the codec.

FIG. 4 illustrates a time-line associated with the onset of voice received at the input of the transducer and the generation of packets containing voice data based on the transducer output. At 410, speaking begins at the input of the transducer. At 420, the VAD turns ON in response to the detection of an audio transducer output, which is responsive to a voice input. There is typically some delay 412 between the onset of voice activity, at 410, and the time the VAD turns ON at 420. There is also a delay or gap 430 between the onset of voice activity, as detected by the VAD, and the time a packet based upon the voice activity is generated and output to the buffer at 440.

In FIG. 2, at 230, audio data packets generated by a codec are output to a buffer where the packets are queued for transmission by a transmitter. FIG. 3 illustrates a buffer 340 having an output to a transmitter. The transmitter is not shown in FIG. 3, but transmitters capable of modulating and transmitting packets are well known to those having ordinary skill in the art and thus are not further discussed herein. In the exemplary mobile station, the transmitter is compliant with the GPRS GSM wireless communication protocol, but in other embodiments the transmitter may operate pursuant to some other protocol.

In FIG. 2, at 240, the setup of a temporary block flow is initiated upon detecting voice activity. The TBF setup preferably occurs before buffering any packets containing voice data based on the detected voice activity. In one embodiment, the TBF is setup by generating and buffering a packet devoid of voice data. The packet devoid of voice data is buffered upon detecting voice activity input to the transducer. This packet generally includes some header information but no data. The packet devoid of voice data is buffered before buffering the packet containing voice data based upon the voice activity input to the transducer. In one embodiment, the setup of the temporary block flow is initiating upon buffering the packet devoid of voice data. In this case, the packet devoid of voice data initiates TBF set-up before the voice data packet is output to the buffer, thus reducing the delay that would otherwise result if TBF set-up was not initiated until the first voice data packet was buffered. In FIG. 4, for example, the TBF setup would occur sometime after the VAD turns ON but before buffering the first packet at 440.

In FIG. 3, the device 300 includes a packet generating entity 350 capable of outputting a packet devoid of data, for example, a packet device of voice data. In one embodiment, a control module, coupled to the packet generating entity, is configured to prompt the packet generating entity to output the packet devoid of voice data to the buffer, before the audio data packet is output to the buffer, when the audio activity detector detects audio input to the audio transducer. In one implementation, the control module is digital code or software executed by a controller 360. The controller has an input coupled to the VAD and an output coupled to the packet generating entity. The controller is thus capable of detecting when the VAD turns ON and OFF. In FIG. 3, the packet generator 350 is illustrated as an entity separate from the controller 360, though in some implementations the packet generating function of the generator 350 may be performed by the controller.

In one embodiment, the presence of a packet queued for transmission is the basis for maintaining a previously established TBF. Thus the TBF is released when the packets queued in the buffer have been depleted. Similarly, in the absence of a TBF, the loading of a packet in the buffer will precipitate the establishment of a TBF. The MS sends a message to the network to request assignment of a packet channel. The establishment and/or maintenance of TBF based on the presence of packets in the buffer are well known generally to those having ordinary skill in the art.

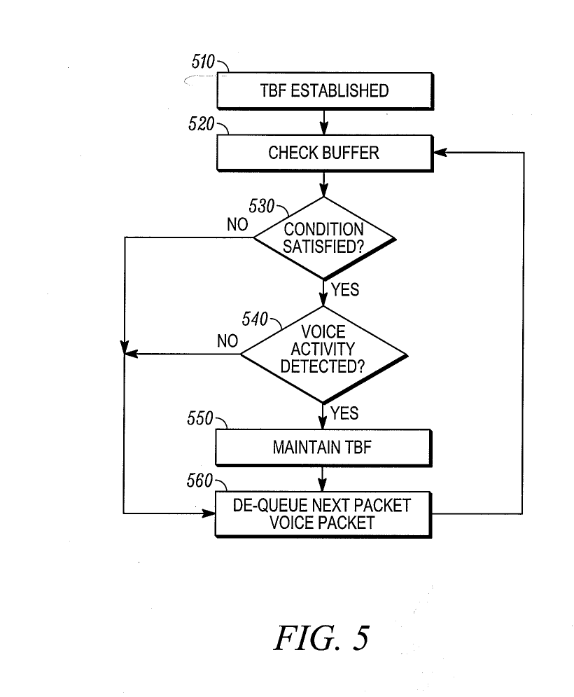

Generally, if voice packets are queued for transmission, TBF is maintained and the packets are de-queued for transmission by the transmitter until the buffer has been depleted. According to another aspect of the disclosure, after TBF has been established, TBF is maintained as long as voice activity is present. In FIG. 5, TBF is established at 510, either as discussed above or according to some other mechanism for setting up TBF, for example, the prior art method of initiating TBF setup discussed hereinabove. At 520, in embodiments where the maintenance of TBF is based on the presence of packets in the buffer, the buffer is checked to determine whether and/or how many packets are queued for transmission. In FIG. 3, the controller 360 monitors the packets queued in the buffer 340.

In FIG. 5, at 530, a determination is made as to whether a condition is satisfied based on the buffer check. In this case, satisfaction of the condition prompts action that will maintain TBF. In FIG. 5, when the condition is not satisfied, the number of packets queued for transmission is sufficient to maintain TBF, and the de-queuing process proceeds at 560 where the next packet is de-queued for transmission. At 530, when the condition is satisfied and voice activity is not detected at 540, the process proceeds at 560 where the next packet, if any, is de-queued for transmission and the TBF is released or allowed to expire.

In FIG. 5, at 530, when the condition is satisfied and voice activity is detected at 540, TBF is maintained at 550. In embodiments where TBF is established and/or maintained based on the presence of one or more packets queued in the buffer for transmission, TBF is maintained by buffering a packet devoid of data, for example, voice data, (dummy packet) when the number of queued packets in the buffer drops to a specified level. If the number of queued packets drops to zero, a dummy packet must be buffered before the expiration of any time-out period after which TBF will be released. If there is no time-out period, a dummy packet must be buffered before the last remaining packet is de-queued. In FIG. 3, the dummy packet, which is devoid of voice data, may be generated and sent to the buffer 340 by the packet generator 350 under control of the controller 360.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a wireless communication device, the method comprising:
detecting voice activity when the wireless communication device is not in a temporary block flow;
generating a packet containing voice data based on the voice activity;
buffering the packet containing voice data for transmission;
initiating setup of a temporary block flow upon detecting the voice activity and before buffering the packet containing voice data.

2. The method of claim 1, detecting the voice activity by monitoring a state of a voice activity detection module output.

3. The method of claim 1,
generating a packet devoid of voice data upon detecting the voice activity,
buffering the packet devoid of voice data before buffering the packet containing voice data;
initiating setup of the temporary block flow upon buffering the packet devoid of voice data.

4. The method of claim 1, maintaining the temporary block flow as long as voice activity is present.

5. The method of claim 4,
monitoring a buffered queue of packets,
maintaining the temporary block flow by buffering a packet devoid of voice data when the buffered queue of packets containing voice data satisfies a condition and only if voice activity is detected.

6. The method of claim 1,
monitoring a buffered queue of packets after the temporary block flow has been setup,
maintaining the temporary block flow by buffering a packet devoid of voice data when the buffered queue of packets satisfies a condition and only if voice activity is detected.

7. The method of claim 6, releasing the temporary block flow upon transmitting a last of the buffered packets, only if voice activity is not detected.

8. A wireless communication device, comprising:
an audio transducer having an electrical output;
an audio activity detector having an input coupled to the audio transducer output, the audio activity detector detecting audio input to the audio transducer;
a codec having an input coupled to the output of the audio transducer, the codec outputting an audio data packet based on the output of the audio transducer after onset of audio input to the transducer;
a buffer coupled to the output of the codec;
a control module having an input coupled to the audio activity detector, the control module configured to prompt initiating setup of a temporary block flow when the audio activity detector detects audio input to the audio transducer, the control module configured to prompt initiating setup of the temporary block flow before the audio data packet is output to the buffer.

9. The device of claim 8,
the audio activity detector turns ON upon detecting audio input to the audio transducer,
the control module configured to prompt initiating setup of the temporary block flow when the audio activity detector turns ON.

10. The device of claim 8,
a packet generating entity capable of outputting a packet devoid of voice data,
the buffer coupled to the output of the packet generating entity, control module coupled to the packet generating entity, the control module configured to prompt the packet generating entity to output a packet devoid of voice data to the buffer, before the audio data packet is output to the buffer, when the audio activity detector detects audio input to the audio transducer,
wherein receipt of the packet devoid of voice data by the buffer initiates setup of a temporary block flow.

11. The device of claim 8, the controller configured to maintain the temporary block flow, after temporary block flow has been set-up, only if audio input is detected by the audio activity detector regardless of the availability of buffered audio data packets for transmission.

12. The device of claim 11,
a packet generating entity capable of outputting a packet devoid of voice data,
the buffer coupled to the output of the packet generating entity,
the controller configured to monitor a number of audio data packets queued in the buffer after temporary block flow has been set-up,
the controller configured to prompt the packet generating entity to output a packet devoid of voice data if the number of audio data packets queued in the buffer satisfies a condition and only if the audio input is detected by the audio activity detector.

13. A method in a wireless communication device, the method comprising:
detecting voice activity when the wireless communication device is in a temporary block flow;
generating a packet containing voice data based on the voice activity;
buffering the packet containing voice data for transmission;
maintaining the temporary block flow as long as voice activity is present regardless of the availability of a buffered packet containing voice data for transmission.

14. The method of claim 13,
monitoring a buffered queue of packets after the temporary block flow has been setup,
maintaining the temporary block flow by buffering a packet devoid of voice data when the buffered queue of packets containing voice data packets satisfies a condition and only if voice activity is detected.

15. The method of claim 14, releasing the temporary block flow upon transmitting a last of the buffered packets and only if voice activity is not detected.
